(19) United States
(12) Patent Application Publication
(10) Pub. No.: US 2005/0114632 A1
(43) Pub. Date: May 26, 2005

(54) Method and apparatus for data speculation in an out-of-order processor

(75) Inventor: Sailesh Kottapalli, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 10/718,750

(22) Filed: Nov. 21, 2003

(51) Int. Cl. G06F 9/30

(52) U.S. Cl. 712/225; 712/217

(57) ABSTRACT

A method and apparatus for utilizing data speculation concurrently with out-of-order instruction execution is disclosed. In one embodiment, a test instruction corresponding to a previously-issued advanced load instruction has a second instance of the logical destination register used by the advanced load appended as a logical source register during a decode stage. When out-of-order register renaming occurs, the appended source register may be mapped to the same physical register as that used in the first instance by the advanced load instruction. This may facilitate the determination of whether or not the results of the advanced load instruction are valid.

### FIELD

The present disclosure relates generally to microprocessors, and more specifically to microprocessors capable of data speculation and out-of-order execution.

### BACKGROUND

Modern microprocessors may support data speculation to enhance performance. In one embodiment of data speculation, load instructions, which may load registers with data stored in memory, may be placed by the compiler in advance of the program location where they were originally intended. The reason for this is because load instructions may take considerably more time to complete than other kinds of instructions. A test instruction may be placed in the location of the original load instruction, and if the speculative load instructions produce valid results the program may then use them. If the test instruction determines that the speculative load instruction produced invalid results, then a recover procedure may be initiated.

Microprocessors capable of Out-Of-Order (OOO) execution, unlike In-Order microprocessors, allow instructions to be executed based on dynamic data-flow requirements rather than the compile time order of the instruction. OOO microprocessors fetch instruction according to program order, execute the individual instruction in an order enforced by the data-flow requirements, and then commit the semantic effects (updating the machine state) in the program order. Among other benefits, OOO microprocessors may achieve higher performance by removing name-space collisions (anti-dependencies) and write-after-write (WAW) hazards. This is achieved by renaming all instruction targets (architectural destination registers) into a large pool of physical registers. Each the following uses (e.g. reads) of the same architectural register may then be mapped to the same physical register.

However, the use of OOO register renaming may conflict with the operation of conventional methods of determining whether speculative data load instructions produced valid results. For example, an OOO register renaming stage may map various instances of a destination logical register to more than one destination physical register. A test instruction subsequent to a speculative load instruction may not be able to ascertain whether the speculative load was successful. In addition, even if the speculative load was successful, it may be difficult to obtain the actual data from the correct destination physical register.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram showing the testing of an advanced load in a processor, according to one embodiment.

FIG. 2 is a diagram showing the testing of an advanced load with an intervening store, according to one embodiment.

FIG. 3 is a diagram showing the testing of an advanced load with appending a destination register as a source register, according to one embodiment of the present disclosure.

FIG. 4 is a diagram showing the testing of an advanced load, according to another embodiment of the present disclosure.

FIG. 5 is a diagram showing the testing of an advanced load with appending a destination register as a source register, according to another embodiment of the present disclosure.

FIG. 6 is a block diagram showing stages in a processor pipeline, according to one embodiment of the present disclosure.

FIGS. 7A and 7B are block diagrams of microprocessor systems, according to two embodiments of the present disclosure.

### DETAILED DESCRIPTION

The following description describes techniques for a processor to use the advanced load instructions of data speculation concurrently with out-of-order (OOO) instruction scheduling. In the following description, numerous specific details such as logic implementations, software module allocation, bus signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. In certain embodiments the invention is disclosed in the form of an Itanium™ Processor Family (IPF) processor or in a Pentium™ family processor such as those produced by Intel™ Corporation. However, the invention may be practiced in other kinds of processors that may wish to use data speculation concurrently with OOO instruction execution.

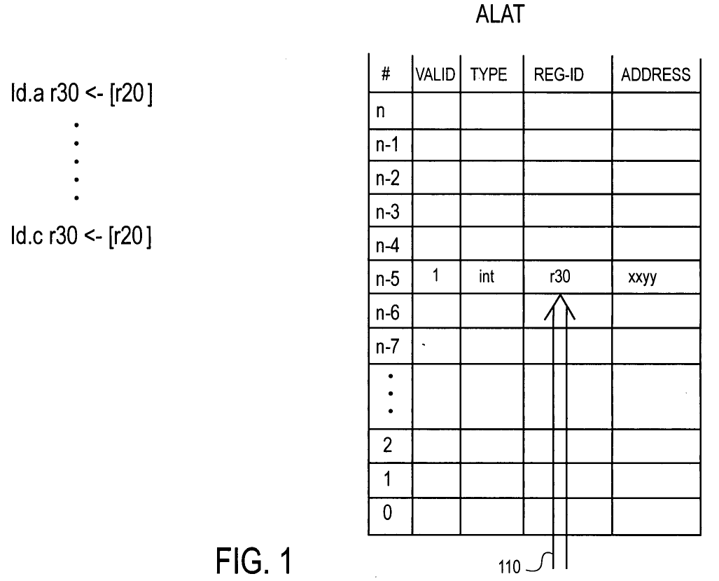

Referring now to FIG. 1, a diagram shows the testing of an advanced load in a processor, according to one embodiment. A compiler may generally place instructions with an eye towards execution latency. For example, an instruction that takes two periods to complete execution may be placed two periods before another instruction that receives the results of the first instruction. A compiler may efficiently deal with such fixed execution latencies. However, memory reference instructions, such as load instructions, may take an unknown and generally unknowable amount of time. If a load instruction hits in the lowest-level cache, the time taken may be measured in tens of instruction periods. If the load misses and needs to reference system memory, the time taken may be measured in hundreds of instruction periods.

In order to efficiently use load instructions, compilers may make use of an advanced load instruction, placing the load far ahead of where the load would be written in the source code. As this load may be invalid by the time the load would normally take place due to subsequent updates, a test instruction may be placed in the location where the load was written in the source code. If the test instruction finds that the results of the advanced load are valid, then the results may be used. Otherwise, some kind of recovery for the invalid advanced load may need to be performed.

In the FIG. 1 embodiment, the representation of the advanced load may be given by the mnemonic “ld.a r30←[r20]”, where ld.a means “load advanced”, logical register r30 is the destination register for the load, and [r20] indicates that the address in memory for the load is located in logical source register 20. Here the test instruction is shown as a load check instruction. The representation of the load check instruction may be given by the mnemonic “ld.c r30←[r20]”, where ld.c means “load check”, and the registers are the same as used above in the ld.a example.

In the code fragment of FIG. 1, the load check instruction has been placed at the location where the original load was place in the source code, and the advanced load instruction has been placed several instructions in front of the load check instruction. When the advanced load instruction is executed, an actual load takes place into logical destination register r30. When this occurs, a validation circuit may be notified in order to track the valid status of the advanced load. In one embodiment, an advanced load address table (ALAT) may be used. The ALAT may be implemented as a content-addressable-memory (CAM) with n lines for entries. In one embodiment, the entries may be written in response to the execution of an advance load instruction, and may include a validity field or bit, a data type (integer or floating point) field, a register identification field, and a load-from address field. In the FIG. 1 example, when the advanced load instruction is executed, an entry is made in ALAT at line n-5, including a “1” in the validity bit, an “int” in the type field, the destination register r30 in the register identification field, and the contents xxyy of source register r20 in the address field.

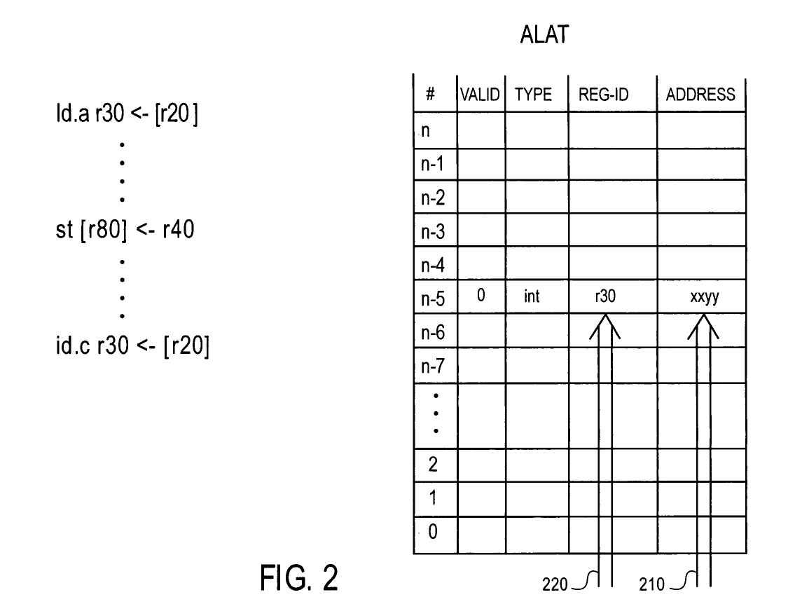

Later on in execution, when load check instruction is executed, the ALAT may be queried to see whether the results of the advanced load are still valid. As the ALAT may be addressed by its contents, the ALAT may be searched 110 in the register identification field for the destination register r30 of the load check instruction. If a match is found, and the validity bit is “1”, then the results of the advanced load are determined to be valid and the effect of the load check instruction is a no-operation. If, however, either no match is found, or if the validity bit is “0”, then the results of the advanced load are determined to be invalid, and the load check instruction itself executes as a load instruction. One reason for finding a “0” in the validity bit is discussed below in connection with FIG. 2.

Referring now to FIG. 2, a diagram shows the testing of an advanced load with an intervening store, according to one embodiment. Consider the advanced load instruction and load check instruction of FIG. 1, but with an, intervening store instruction. Here the store instruction may be given by the mnemonic “st [r80]←r40”, where st means “store”, logical register r80 contains the address in memory to store the data, and r40 is the logical register containing the data. In this example, let r80 contain the same address xxyy as used by the advanced load instruction. Thus this store instruction will overwrite the memory address accessed by the advanced load instruction. In one embodiment, whenever a store instruction is executed, the ALAT may be searched 210 in the address field for the address xxyy of the advanced load instruction. If a match is found, as is true in this example, the validity bit may be set to “0”. Then when the load check instruction subsequently executes, and the corresponding search 220 in the register identification field, a reading of the validity bit will return a “0” indicating the advanced load instruction's results are now invalid.

The method described above may encounter problems when used in a processor that supports out-of-order execution of instructions. In order-to support out-of-order execution, a register renaming stage in the pipeline may map a physical register to each logical register used as an operand in an instruction. In one embodiment, the register renaming stage will map a logical register to a new physical register each time the logical register is used as a destination register for an instruction. When a logical register is used as a source register for an instruction, the register renaming stage may use the existing mapping for that logical register to a physical register.

The register renaming may cause a problem with using advanced load instructions because the advanced load instruction and its corresponding test instruction may use the same destination logical register. If the register renaming stage operates as described above, the first instance of the destination logical address in the advanced load instruction will be mapped to one physical register, and the second instance of the destination logical address in the test instruction will be mapped to another distinct physical register. When the advanced load instruction causes an entry to be written into the ALAT, the first physical register will be written into the register identification field for that entry. When the test instruction subsequently searches the register identification field with its second physical register, a proper matching may not be possible.

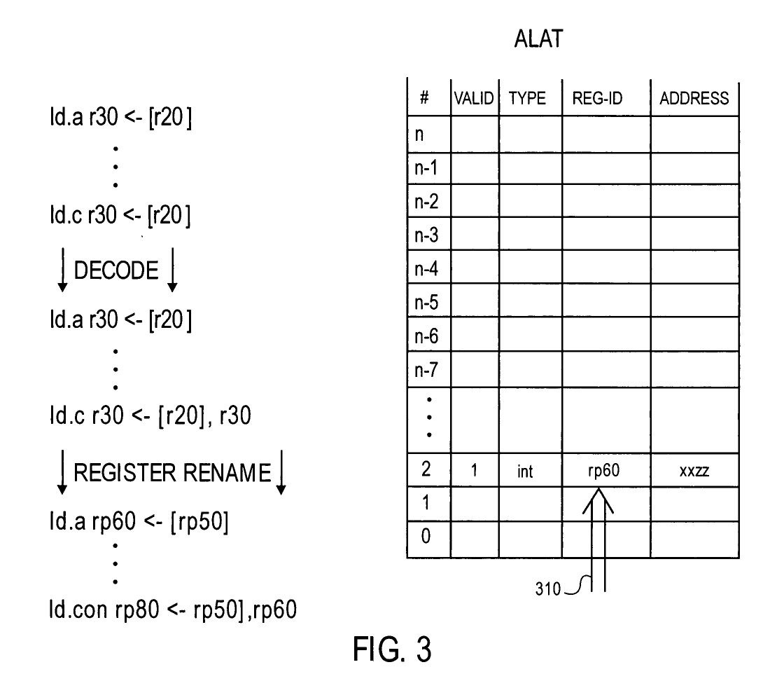

Referring now to FIG. 3, a diagram shows the testing of an advanced load with appending a destination register as a source register, according to one embodiment of the present disclosure. Let the ld.a and ld.c instructions be similar to those of the FIG. 1 and FIG. 2 examples. In one embodiment, a decode stage of the pipeline of the processor may decode the ld.a advanced load instruction in the traditional manner. However, the decode stage may decode the ld.c load check instruction into a related test instruction, called a load conditional instruction with mnemonic “ld.con”. The load conditional may be similar to its related load check instruction but with the logical destination register appended a second time as a second source operand. FIG. 3 shows how the decoded load conditional ld.con instruction has logical register r30 appearing first as a destination register and second as a newly-appended source register.

When the results of the decode stage are then run through a register renaming stage, the mappings of logical registers to physical registers may be as shown in FIG. 3. The first instance of logical register r30 used as a destination register in ld.a may be mapped, for example, to physical register rp60. The second instance of logical register r30 being used as a destination register in ld.con may be mapped to a different physical register, such as, for example, rp80. However, the use of logical register r30 as the newly-appended source register in ld.con will cause it to be mapped, using the existing mapping of the register renaming stage, to physical register rp60.

When the ld.a instruction of FIG. 3 is executed, an entry in the ALAT will be made. In this example the entry may be placed into line 2 of the ALAT, and may have rp60 written into the register identification field and may have the contents of rp50, for example the address xxzz, written into the address field. When the ld.con instruction of FIG. 3 is executed, the search 310 on the register identification fields of the ALAT may be performed for the newly appended source physical register rp60, and not on the destination physical register rp80. In this way the entry written by the corresponding ld.a may be located because of the commonality of the physical register used as a destination physical register for the ld.a instruction and also as a newly-appended source register for the ld.con instruction. Invalidation by an intervening store instruction may be performed as in the FIG. 2 example.

If the search 310 initiated during the execution of the ld.con finds a “1” in the validity bit, then the results of the load performed by the ld.a instruction are determined to be valid. However, the valid results are in rp60, and not in the destination physical register rp80 of the ld.con instruction. Therefore in one embodiment the ld.con instruction performs a contents move from the newly-appended source physical register rp60 to the destination physical register rp80. It may be noted that the ld.c instruction of the prior are would perform a no-operation upon finding that the results of the corresponding ld.a are valid.

If the search 310 initiated during the execution of the ld.con finds a “0” in the validity bit, then the results of the load performed by the ld.a instruction are determined to be invalid. In this case, the ld.con instruction initiates a load from the address contained in the source physical register rp50 and places the results in the destination physical register rp80. It may be noted that the ld.c instruction of the prior art would initiate essentially the same load upon finding that the results of the corresponding speculative load is invalid.

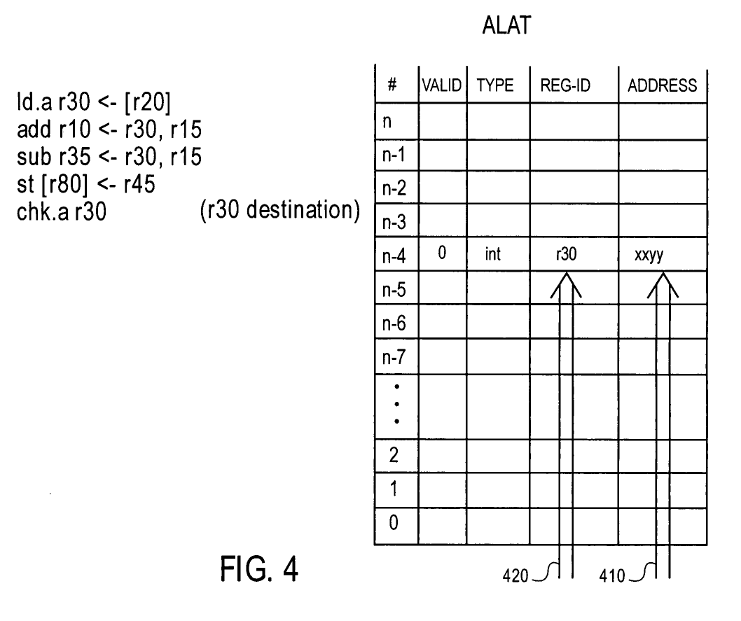

Referring now to FIG. 4, a diagram shows the testing of an advanced load, according to another embodiment of the present disclosure. In cases where one or more instructions may consume the results of an advanced load before the test instruction is placed, the test instruction may be a speculation check instruction, mnemonic chk.a. For example, FIG. 4 shows a ld.a instruction placing its advanced load into its destination register r30. At this time r30 contains the data contained in memory at the address xxyy contained in source register r20. An entry may be made into the ALAT, say at entry n-4, that places r30 into the register identification field and xxyy into the address field.

The ld.a instruction may be followed by an addition add instruction and a subtraction sub instruction, both of which use r30 as a source register. A store instruction may then follow, which places the contents of r45 into memory at the address contained in source register r80. Consider that r80 also contains the address xxyy. Then the store instruction will initiate a search 410 in the address field of the ALAT for xxyy, and when it finds it in entry n-4 it may set the validity bit to be

When the speculative check instruction chk.a executes, a search 420 of the register identification field of the ALAT may be initiated for the destination register r30 of the chk.a instruction. The chk.a instruction may be considered a variant of a branch instruction. If the search 420 returns a “1” from the validity bit, then the chk.a acts otherwise as a no-operation and the program continues to the next sequential instruction. If, however, the search 420 returns a “0” from the validity bit, then the chk.a initiates a jump to the address contained in source register r55. An exception recovery routine stored at that address may determine the correct resolution of the write-after-read (WAR) situation caused by the load following the uses of the contents of memory at the xxyy address.

In a situation similar to that of the ld.a instruction, if the logical registers shown in FIG. 4 are mapped by a register renaming stage into physical registers for out-of-order execution, this use of the ALAT may be compromised. The first instance of destination register r30 of the ld.a instruction will be mapped to one destination physical register, and the second instance of destination register r30 of the chk.a instruction will be mapped to a different destination physical register. Therefore the chk.a instruction may not be capable of initiating the search 420 of the register identification field of the ALAT.

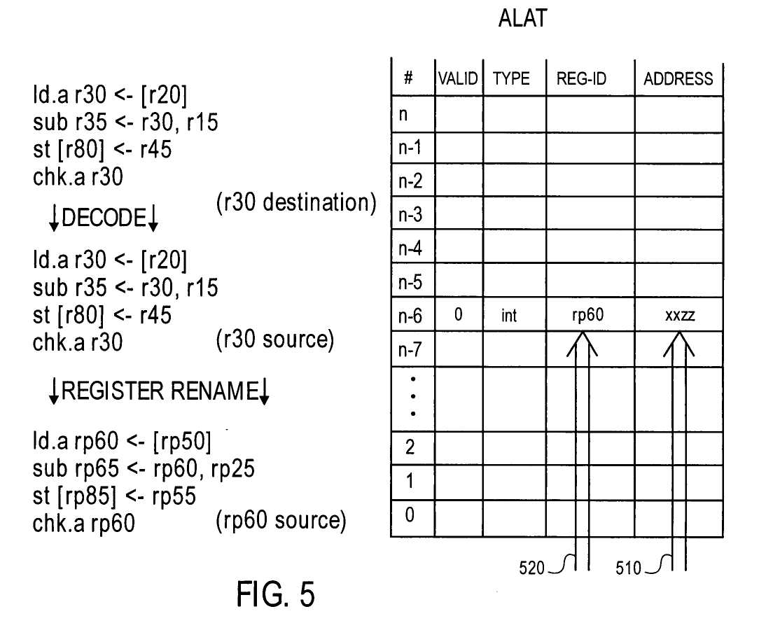

Referring now to FIG. 5, a diagram shows the testing of an advanced load with appending a destination register as a source register, according to another embodiment of the present disclosure. The first code fragment is similar to that of FIG. 4, with both the ld.a instruction and the chk.a instruction using as a destination register logical register r30. When acted upon by the decode stage of a pipeline, the decoded instructions may include a modification to the chk.a instruction. The destination logical register r30 of the chk.a instruction may be changed in function to a source logical register r30. Then when acted upon by the register renaming stage, the logical destination register r30 of the ld.a instruction may be mapped, for example, to physical destination register rp60. Since the instance of r30 in the chk.a instruction is now that of a source register, then the instance of r30 in ld.a as a logical source register will also be mapped to physical register rp60. This enables the chk.a instruction to initiate the search 520 on the register identification field of the ALAT and find the entry made at the time of the ld.a instruction's execution. The other functionality of the chk.a instruction may be unmodified from that of the FIG. 4 example.

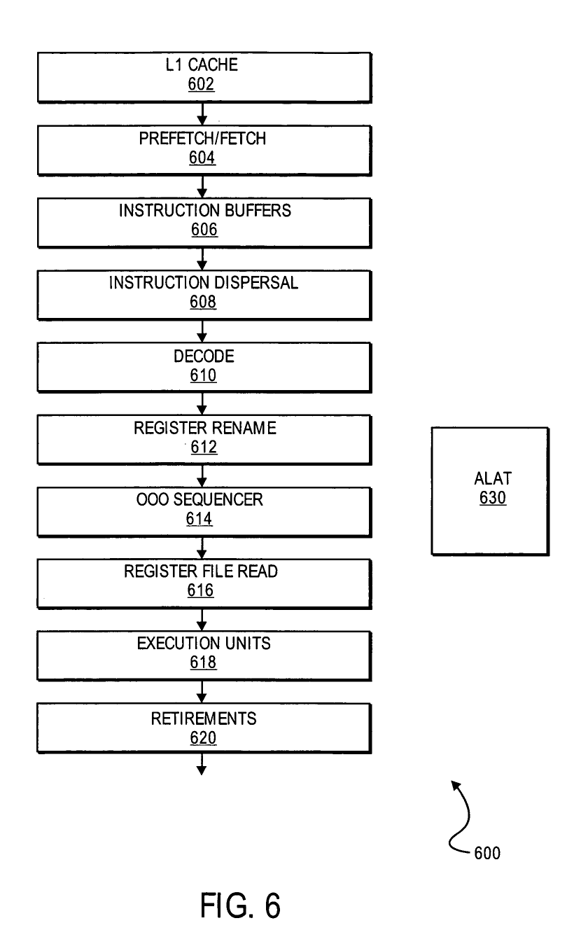

Referring now to FIG. 6, a block diagram shows stages in a processor pipeline 600, according to one embodiment of the present disclosure. Instructions may be fetched or prefetched from a level one (L1) cache 602 by a prefetch/fetch stage 604. These instructions may be temporarily kept in one or more instruction buffers 606 before being sent on down the pipeline by an instruction dispersal stage 608. In other embodiments, the instruction buffers 606 may be replaced by a trace cache stage.

A decode stage 610 may take an instruction from a program and produce one or more machine instructions. In one embodiment, the decode stage 610 may take a generic “ld.c” load check instruction
ld.c r30←[r20]
   and decode it into a load conditional instruction
ld.con r30←[r20], r30
   where the ld.con instruction has appended an additional instance of the logical destination register r30 as a logical source register. Additionally, the decode stage 610 may take a generic “chk.a” speculative check instruction
chk.a r30
   and decode it into a modified speculative check instruction
chk.a r30
   where the decoded chk.a has changed the destination logical register r30 into a source logical register r30.

After exiting the decode stage 610, the instructions may enter the register rename stage 612, where instructions may have their logical registers mapped over to actual physical registers prior to execution. The register rename stage 612 may make a new mapping of logical register to physical register each time a logical register is used as a destination register. The register rename stage 612 may use a previous mapping of logical register to physical register when a logical register is used as a source register.

Upon leaving the register renaming stage 612, the machine instructions may enter an out-of-order (OOO) sequencer 614. The OOO sequencer 614 may schedule the various machine instructions for execution based upon the availability of data in various source registers. Those instructions whose source registers are waiting for data may have their execution postponed, whereas other instructions whose source registers have their data available may have their execution advanced in order. In some embodiments, they may be scheduled for execution in parallel.

Upon leaving the OOO sequencer 614, the physical source registers may be read in register read file stage 616 prior to the machine instructions entering one or more execution units 618. During the process of executing advanced load instructions, the corresponding test instructions, and any intervening store instructions, entries may be made to and modified in the ALAT 630. After execution in execution units 618, the machine instructions may in a retirement stage 620 update the machine state and write to the physical destination registers depending upon the resolved state of the corresponding predicate values.

The pipeline stages shown in FIG. 6 are for the purpose of discussion only, and may vary in both function and sequence in various processor pipeline embodiments.

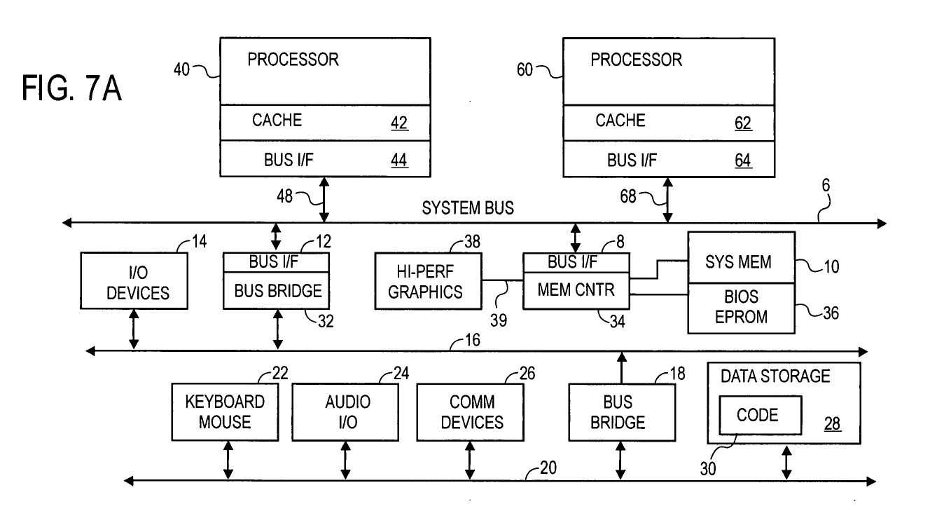

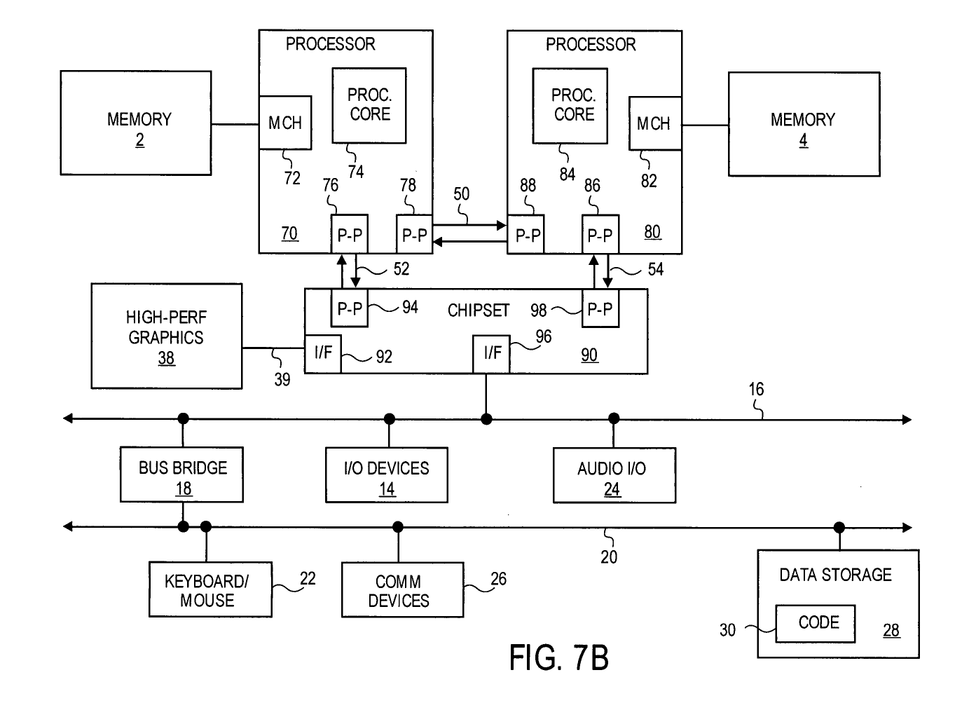

Referring now to FIGS. 7A and 7B, schematic diagrams of systems including a processor supporting execution of data speculation in an out-of-order execution environment are shown, according to two embodiments of the present disclosure. The FIG. 7A system generally shows a system where processors, memory, and input/output devices are interconnected by a system bus, whereas the FIG. 7B system generally shows a system were processors, memory, and input/output devices are interconnected by a number of point-to-point interfaces.

The FIG. 7A system may include several processors, of which only two, processors 40, 60 are shown for clarity. Processors 40, 60 may include level one caches 42, 62. The FIG. 7A system may have several functions connected via bus interfaces 44, 64, 12, 8 with a system bus 6. In one embodiment, system bus 6 may be the front side bus (FSB) utilized with Pentium® class microprocessors manufactured by Intel® Corporation. In other embodiments, other buses may be used. In some embodiments memory controller 34 and bus bridge 32 may collectively be referred to as a chipset. In some embodiments, functions of a chipset may be divided among physical chips differently than as shown in the FIG. 7A embodiment.

Memory controller 34 may permit processors 40, 60 to read and write from system memory 10 and from a basic input/output system (BIOS) erasable programmable read-only memory (EPROM) 36. In some embodiments BIOS EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface. Memory controller 34 may direct read data from system memory 10 to the high-performance graphics circuit 38 across high-performance graphics interface 39.

The FIG. 7B system may also include several processors, of which only two, processors 70, 80 are shown for clarity. Processors 70, 80 may each include a local memory channel hub (MCH) 72, 82 to connect with memory 2, 4. Processors 70, 80 may exchange data via a point-to-point interface 50 using point-to-point interface circuits 78, 88. Processors 70, 80 may each exchange data with a chipset 90 via individual point-to-point interfaces 52, 54 using point to point interface circuits 76, 94, 86, 98. Chipset 90 may also exchange data with a high-performance graphics circuit 38 via a high-performance graphics interface 92.

In the FIG. 7A system, bus bridge 32 may permit data exchanges between system bus 6 and bus 16, which may in some embodiments be a industry-standard architecture (ISA) bus or a peripheral component interconnect (PCI) bus. In the FIG. 7B system, chipset 90 may exchange data with a bus 16 via a bus interface 96. In either system, there may be various input/output I/O devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
issuing an advanced load instruction with a first instance of a first destination register;
decoding a test instruction with a second instance of said first destination register where said second instance of said first destination register is decoded as a first source register;
register renaming said first instance of said first destination register and said first source register to a first physical register; and
validating results of said advanced load instruction using said test instruction with said first physical register.

2. The method of claim 1, wherein said test instruction is a load conditional instruction with said second instance of said first destination register.

3. The method of claim 2, further comprising register renaming said second instance of said first destination register to a second physical register.

4. The method of claim 3, wherein said test instruction operates to move contents of said first physical register to said second physical register when said validation indicates said results are valid.

5. The method of claim 1, wherein said test instruction is a speculation check instruction with said second instance of said first destination register.

6. The method of claim 1, wherein said validating includes searching a table for an entry with said first physical register.

7. A processor, comprising:
a decoder to decode a test instruction with a first instance of a first destination register corresponding to a advanced load instruction with a second instance of said first destination register wherein said first instance is decoded as a first source register; and
a register renaming stage to rename said second instance of said first destination register and said first source register to a first physical register.

8. The processor of claim 7, wherein said test instruction is a load conditional instruction.

9. The processor of claim 8, wherein said register renaming stage to rename said first instance of said first destination register to a second physical register.

10. The processor of claim 9, wherein said load conditional instruction operates to move contents of said first physical register to said second physical register when a validation circuit indicates that results of said advanced load instruction are valid.

11. The processor of claim 10, wherein said validation circuit is an advanced load address table.

12. The processor of claim 7, wherein said test instruction is a speculation check instruction.

13. The processor of claim 12, wherein said speculation check instruction is a no-operation when a validation circuit indicates that results of said advanced load instruction are valid.

14. The processor of claim 13, wherein said validation circuit is an advanced load address table.

15. A processor, comprising:
means for issuing an advanced load instruction with a first instance of a first destination register;
means for decoding a test instruction with a second instance of said first destination register where said second instance of said first destination register is decoded as a first source register;
means for register renaming said first instance of said first destination register and said first source register to a first physical register; and
means for validating results of said advanced load instruction using said test instruction with said first physical register.

16. The processor of claim 15, wherein said test instruction is a load conditional instruction with said second instance of said first destination register.

17. The processor of claim 16, further comprising means for register renaming said second instance of said first destination register to a second physical register.

18. The processor of claim 17, wherein said test instruction operates to move contents of said first physical register to said second physical register when said validation indicates said results are valid.

19. The processor of claim 15, wherein said test instruction is a speculation check instruction with said second instance of said first destination register.

20. The processor of claim 15, wherein said means for validating includes a table searchable for an entry with said first physical register.

21. A system, comprising:
a processor including a decoder to decode a test instruction with a first instance of a first destination register corresponding to a advanced load instruction with a second instance of said first destination register wherein said first instance is decoded as a first source register, and a register renaming stage to rename said second instance of said first destination register and said first source register to a first physical register;.
an interface to couple said processor to input-output devices; and
an audio input-output circuit coupled to said interface and to said processor.

22. The system of claim 21, wherein said test instruction is a load conditional instruction.

23. The system of claim 22, wherein said register renaming stage to rename said first instance of said first destination register to a second physical register.

24. The system of claim 23, wherein said load conditional instruction operates to move contents of said first physical register to said second physical register when a validation circuit indicates that results of said advanced load instruction are valid.

25. The system of claim 24, wherein said validation circuit is an advanced load address table.

26. The system of claim 21, wherein said test instruction is a speculation check instruction.

27. The system of claim 21, wherein said speculation check instruction is a no-operation when a validation circuit indicates that results of said advanced load instruction are valid.

28. The system of claim 27, wherein said validation circuit is an advanced load address table.
